(19) United States
(12) Patent Application Publication
(10) Pub. No.: US 2006/0214498 A1
(43) Pub. Date: Sep. 28, 2006

(54) Coaxial structure of auxiliary wheels and a primary wheel

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/085,103

(22) Filed: Mar. 22, 2005

(51) Int. Cl. B60B 11/00

(52) U.S. Cl. 301/36.1

(57) ABSTRACT

A coaxial structure of auxiliary wheels and a primary wheel includes a frame, an axle, a primary wheel and two auxiliary wheels. The frame is pivotally connected to the axle. Both the primary wheel and the auxiliary wheels are separately inserted with bearings or sleeves. The bearings or the sleeves are further inserted onto the axle. Both the primary and the auxiliary wheels wear tires made of different material to increase the contact area with the ground while the frame is inclined to take a turn to prevent from turning over.

### BACKGROUND OF THE INVENTION

(a) Field of the Invention

The present invention relates to a coaxial structure of auxiliary wheels and a primary wheel, and more particularly, to one adapted to the wheel of a fun or sports equipment for children such as a folding scooter, tricycle, bicycle, skateboard, baby walker, suitcase, push cart, shopping cart, toy car, or balancer of exerciser equipment; and a coaxially pivoted primary wheel and auxiliary wheels within the frame to increase contact area with the ground while the frame is inclined to take a turn.

(b) Description of the Prior Art

Folding scooters, tricycles, and bicycles generally available in the market for children are vulnerable to tilt over while taking a turn due to poor manipulation by the children. Therefore, two auxiliary wheels each in smaller diameter are respectively pivoted to both sides of the frame of the wheel. However, both auxiliary wheels must be separately pivoted to a smaller wheel rack before being fixed to the frame and they are not coaxially provided.

Addition of the auxiliary wheels and their wheel rack increases manufacturing and assembly costs. More members mean more time spent on assembly. While riding, the wheel rack of the auxiliary wheels can get easily damaged due to collision.

### SUMMARY OF THE INVENTION

The primary purpose of the present invention is to provide a coaxial structure of auxiliary wheels and a primary wheel to be adapted to the wheel of a fun or sports equipment such as a folding scooter, tricycle, bicycle, skateboard, baby walker, suitcase, push cart, shopping cart, toy car, or balancer of exerciser equipment to increase contact area with the ground while the frame is inclined to take a turn to prevent danger to the children user because of turning over by the frame. To achieve the purpose, the present invention comprises a frame, an axle, a primary wheel and auxiliary wheels. Wherein, the frame is pivotally connected to the axle; both the primary wheel and the auxiliary wheels are coaxially provided and separately inserted with bearings or sleeves; and the bearings or the sleeves are then inserted onto the axle. Both the primary wheel and the auxiliary wheels wear tires made of different material, and the tires are either injection molded, casting molded, or directly mounted to the wheel.

The present invention provides the following advantages:

1. Two auxiliary wheels are coaxially pivoted to both outer sides of the primary wheel in the frame to increase the contact area with the ground while the frame is inclined to take a turn to prevent the frame from turning over due to excessive angle of inclination.

2. The rack for the auxiliary wheels otherwise required in the prior art is not seen in the present invention thus to save time and costs in the manufacturing and assembly, and furthermore to avoid failure due to collision during the riding.

3. Both the primary wheel and the auxiliary wheels are made by blow or injection molded; and their tires are either injection or casting molded, or directly mounted to the wheel for easy manufacturing.

### BRIEF DESCRIPTION OF THE DRAWINGS

FIG. 1 is a front view of a first preferred embodiment of the present invention.

FIG. 2 is a front view of a second preferred embodiment of the present invention, partially sectioned.

### DETAILED DESCRIPTION OF THE PREFERRED EMBODIMENTS

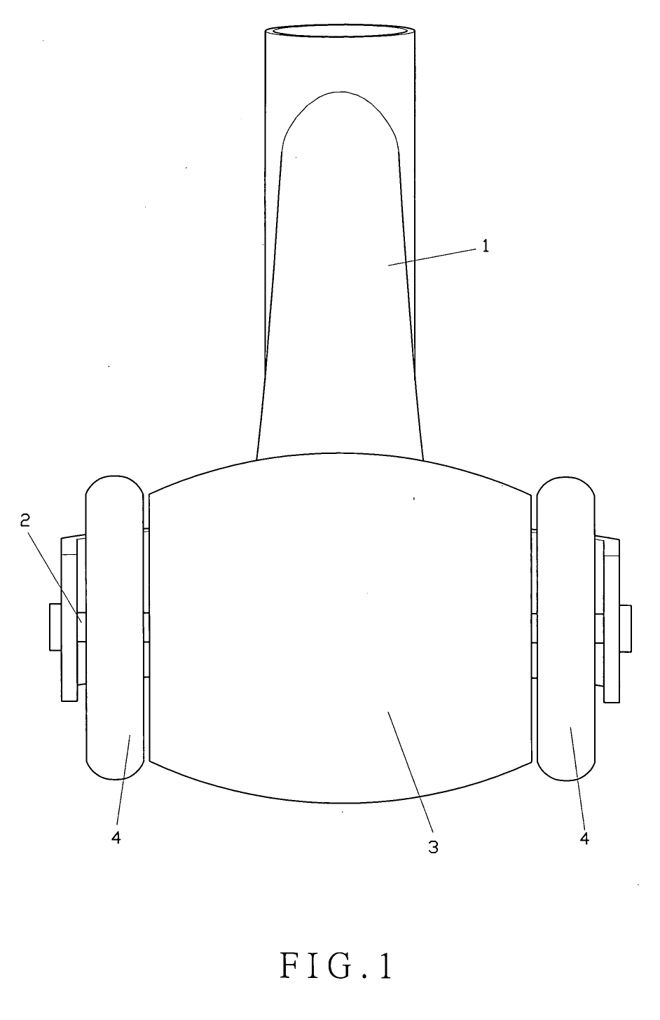

Referring to FIG. 1, a first preferred embodiment of the present invention comprises a frame (1), an axle (2), a primary wheel (3) and two auxiliary wheels (4).

The frame (1) is pivotally connected to the axle (2), and both the primary wheel (3) and the auxiliary wheels (4) are coaxially pivoted into a fork at the front end of the frame (1) by means of the axle (2) thus to be protected by the fork at the front end of the frame (1) from being easily damaged by collision.

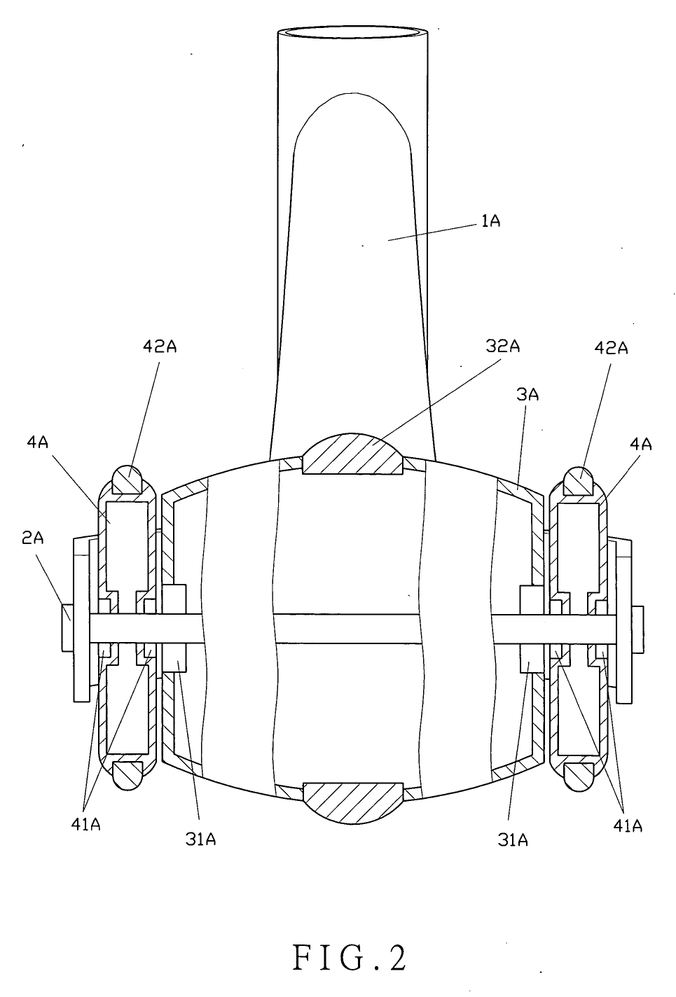

Now referred to FIG. 2, a second preferred embodiment of the present invention comprises a frame (1A), an axle (2A), a primary wheel (3A) and two auxiliary wheels (4A). The frame (1A) is pivotally connected to the axle (2A) and both the primary is wheel (3A) and the auxiliary wheels (4A) are coaxially inserted onto the axle (2A). Bearings (or sleeves) (31A) and (41A) are respectively inserted through the primary wheel (3A) and the auxiliary wheels (4A). The bearings (31A) and (41A) are then inserted onto the axle (2A). Furthermore, both the primary wheel (3A) and the auxiliary wheels (4A) respectively wear a tire (32A), (42A). The tires (32A), (42A) are respectively made of different material by injection molded, casting molded or are directly mounted to the primary wheel (3A) and the auxiliary wheels (4A) so to increase the contact area with the ground while the frame (1A) is inclined to take a turn thus to prevent the frame (1A) from turning over.

What is claimed is:

1. A coaxial structure of auxiliary wheels and a primary wheel comprising a frame, an axle, a primary wheel and two auxiliary wheels; the frame being pivotally connected to the axle; and the primary wheel and the auxiliary wheels being inserted coaxially onto the axle.

2. The coaxial structure of auxiliary wheels and a primary wheel of claim 1, wherein both the primary wheel and the auxiliary wheels are respectively inserted with bearings, and the bearings are then inserted onto the axle.

3. The coaxial structure of auxiliary wheels and a primary wheel of claim 1, wherein both the primary wheel and the auxiliary wheels are respectively inserted with sleeves, and the sleeves are then inserted onto the axle.

4. The coaxial structure of auxiliary wheels and a primary wheel of claim 1, wherein both the primary wheel and the auxiliary wheels respectively wear tires made of different material.

5. The coaxial structure of auxiliary wheels and a primary wheel of claim 4, wherein the tires are injection molded.

6. The coaxial structure of auxiliary wheels and a primary wheel of claim 4, wherein the tires are casting molded.

7. The coaxial structure of auxiliary wheels and a primary wheel of claim 1, wherein the tires are directly mounted to the primary and auxiliary wheels.
